(19) United States
(12) Patent Application Publication
(10) Pub. No.: US 2013/0101354 A1
(43) Pub. Date: Apr. 25, 2013

(54) NOVEL PROCESS FOR THE TEMPORARY COVERING OF CONTAMINATED SOILS

(71) Applicant: SNF SAS, Andrezieux Boutheon (FR)

(72) Inventors: Christophe LIGNIER, Lyon (FR); Herve CASEZ, Pommiers (FR); Stephane DELHEUR, St Marcellin en Forez (FR)

(73) Assignee: SNF SAS, Andrezieux Boutheon (FR)

(21) Appl. No.: 13/651,846

(22) Filed: Oct. 15, 2012

(30) Foreign Application Priority Data
Oct. 21, 2011 (FR) 1159548

(51) Int. Cl. B09C 1/00

(52) U.S. Cl. 405/128.45

(57) ABSTRACT

Process for the temporary covering of contaminated soils, includes applying, to the soil, a leakproof layer based on a water-soluble polymer, and then subsequently a stabilizing layer based on plant fibers.

### CROSS REFENCE TO RELATED APPLICATIONS

This application claims priority of French application No. 1159548 filed on Oct. 21, 2011, the entire contents of which is hereby incorporated herein by reference.

### TECHNICAL FIELD OF THE INVENTION

The present invention relates to the field of the protection or containment of contaminated soils, for instance operations to depollute industrial sites subsequent to them being exploited, ceasing activity or being dismantled or subsequent to an industrial accident. The ICPE (Installation Classée Pour l'Environnement [Classified Installation for Environmental Protection]) legislation and also environmental restrictions mean that manufacturers have to depollute their sites before transferring them or changing their use.

Two benefits of containment are sought: protection of the soil and protection of the air. First of all, it is a question of protecting the soil by limiting as much as possible the propagation of the contaminants present at the surface of the soil to the deeper layers via the effect of percolation of atmospheric water, of the penetration thereof into the soil and of the ability thereof to entrain the contaminants to the subterranean layers. At the same time, it is necessary to prevent the evaporation of volatile contaminants, for instance volatile organic compounds (VOCs) into the atmosphere, and also harmful or toxic dust.

Environmental contaminants are substances which, when they are accidentally or intentionally introduced into the environment, can cause damage to human beings, to the fauna and to the flora. Mention may, for example, be made of hydrocarbons, heavy metals, PCBs, phytosanitary products, microorganisms, bacteria and viruses, radioactive pollutions, oils, dioxins and VOCs.

### BACKGROUND ART

The current solutions for soil containment generally involve covering with covers. The operation consists in placing covers and/or geomembranes over the soil and maintaining them there. Generally, the technique uses two essential elements, namely, firstly, the puncture-resistant felt, which makes it possible to “smooth out” the elements that can damage the upper part by perforation, and secondly, the canvas cover with a PVC-type coating in order to ensure leaktightness over the zones covered.

Containment by covering with covers is a solution that is fastidious and difficult to implement. It requires the filling of ballast bags, placement of the felt, positioning of the ballast bags, maintenance of the covers which may be moved, creased, folded over by climatic events (rain, wind) and treatment of the polluted covers at the end of the works, which are considered to be waste and must be disposed of in an authorized network (generally a center for storage of non-dangerous or dangerous waste).

This maintenance is essential and expensive because it requires the virtually permanent presence of trained and authorized personnel for adjusting the covers and repositioning the ballast bags and pumping the water that is often accumulated and that cannot be disposed of on the same site. This technique also has the following disadvantages: covering with covers is particularly difficult to carry out on banks, and the desired leaktightness is not optimal owing to the non-continuity of the covers and therefore to their poor covering and also to the risk of the leaking of liquids or of gases that can pass through the containment.

Other solutions have been envisioned.

Patent FR 2 127 991 describes a method for protecting polluted soils consisting in mixing a binder with the surface earth (the first 15 cm), in compacting by means of a heavy construction machine and in applying a thin layer of water-insoluble polymer, of polyurethane type, in order to obtain an impermeabilizing effect of the upper layer.

This technique has the drawback of requiring numerous interventions since it is necessary to mix the earth with the binder, and then to compact all of it before applying the second layer. Another drawback of this method is the formation of pockets of water at the surface of the impermeabilizing layer, which can destroy the protection and, through a percolation effect, pollute the deeper ground.

Document WO 97/34054 describes a method for protecting soils against contamination caused by the contents of a storage tank, consisting of 3 steps: application to the soil of a layer based on smectite (clay) and on a polymer, then application of a drainage layer based on silicate (sand, gravel), and, finally, application of a layer based on mineral particles impregnated with oil. This method is complex and has the drawback of positioning the impermeabilizing layer in contact with the atmosphere.

Application WO 98/31770 describes a preferably permanent protection consisting of two layers: a first containing water-insoluble particles which swell in water in contact with the soil, and a “water-repellant”, i.e. surface hydrophobic, polymer film. The same problem of pockets of water arises with the same consequences.

### Technical Problem to be Solved

None of these solutions provide sufficient effectiveness in terms of temporary protection of contaminated soils which is easy to implement, easy to maintain and easily degradable.

There is therefore a need for a method for temporary protection of contaminated soils which is more effective and easier to implement.

### DESCRIPTION OF THE INVENTION

The present invention proposes to overcome the abovementioned problems.

The present invention proposes a novel process for the temporary covering of contaminated soils by virtue of a membrane composed of a leakproofing or impermeabilizing first layer, on the soil, based on a water-soluble polymer, and of a stabilizing second layer, in contact with the atmosphere, allowing mechanical protection, said stabilizing layer being based on plant fibers.

More specifically, the subject of the invention is a process for the temporary covering of contaminated soils, consisting in applying, to the soil, first of all a leakproof layer based on a water-soluble polymer, and then subsequently a stabilizing layer based on plant fibers.

### Leakproof or Impermeabilizing Layer

The first layer applied to the soil has an impermeabilizing role: it makes it possible to create a barrier to gases and fluids while therefore protecting the atmosphere against the volatile contaminants of the soil and while protecting the soil against a percolation effect.

The leakproof or impermeabilizing layer advantageously contains:
from 0.05 to 3% by weight of at least one water-soluble polymer,
from 0.05 to 4% by weight of a film-forming compound;
from 0.001 to 2% by weight of a crosslinking agent comprising at least 2 aldehyde functions;
the remainder to 100% by weight being water.

The impermeabilizing layer can also contain:
up to 3% by weight of at least one thickening polymer;
up to 3% by weight of a pH corrector;
up to 3% by weight of synthetic fibers having a size ranging from 1 to 500 g;
up to 0.5% by weight of a complexing agent;
surfactants, natural gums of guar type, xanthates, carboxymethylcellulose.

The water-soluble polymer systematically present in the leakproof layer can be in solid or liquid form and is obtained from:
at least one nonionic monomer, such as, for example, those chosen from the group comprising acrylamide, methacrylamide, N-vinylmethylacetamide or N-vinylformamide, vinyl acetate, vinylpyrrolidone, methyl methacrylate, dimethylacrylamide, acryloyl morpholine or other acrylic esters, or other ethylenically unsaturated esters, or else other water-insoluble vinyl monomers, such as styrene or acrylonitrile,
optionally copolymerized with one or more cationic monomers chosen from the group comprising diallyldialkylammonium salts, such as diallyldimethylammonium chloride (DADMAC) and dialkylaminoalkyl acrylates and methacrylates, in particular dialkylaminoethyl acrylate (ADAME) and dialkylaminoethyl methacrylate (MADAME), and also the salts thereof acidified or quaternized by the means known to those skilled in the art, such as benzyl chloride, methyl chloride (MeCl), aryl chlorides, alkyl chlorides, dimethyl sulfate, diethyl sulfate, and also dialkyl-aminoalkylacrylamides or -methacrylamides, and also the salts thereof acidified or quaternized in a known manner, for example methacrylamidopropyltrimethylammonium chloride (MAPTAC), and the Mannich products such as quaternized dialkylaminomethylacrylamides;
optionally copolymerized with one or more anionic monomers, such as, for example, monomers having a carboxylic function (for example: acrylic acid, methacrylic acid, and their salts, etc.), monomers having a sulfonic acid function (for example: 2-acrylamido-2-methylpropanesulfonic acid (AMPS) and salts thereof, etc.), vinylsulfonic acids, and ethylene glycol methacrylate phosphate.

The water-soluble polymer will preferably be in the form of an inverse emulsion. Preferably, the polymer will be nonionic and its molecular weight will be greater than 1 million g/mol.

The film-forming compound will, for example, be a latex dispersion comprising a polymer or copolymer obtained from styrene and/or butene and/or acrylic and/or vinyl monomers.

The crosslinking agent comprising at least 2 aldehyde functions may be, for example, formaldehyde and preferably glyoxal.

In the components that can be added to the impermeabilizing layer, the thickening polymer may be natural or synthetic, and liquid or solid. It will preferably be a acrylamide-based crosslinked polymer different than the water-soluble polymer already mentioned.

The pH corrector may be any basic or acidic compound which makes it possible to adjust the pH of the composition of the impermeabilizing layer, it will preferably be sodium hydroxide.

The synthetic fibers will preferably be polypropylene fibers.

The complexing agent will preferably be based on the following compounds: pentasodium diethylenetriamine pentaacetate, EDTA (ethylenediaminetetraacetic acid) or NTA (N-(hydroxyethyl)ethylenediaminetriacetic acid).

The impermeabilizing layer is applied in the liquid state to the soil to be treated, preferably by spraying, at a thickness of between 1 and 50 mm, preferably between 2 and 10 mm.

According to the invention, the leakproof layer is applied to the soil in the liquid state and gelled under the action of the crosslinking agent. In order to avoid gelling of the composition before application, the crosslinking agent is added to the constituent composition of the leakproofing layer just before application. Equipment of hydroseeder® type will preferentially be used in order to carry out the application.

### Stabilizing Layer

The second layer applied to the leakproof layer and in contact with the surface has the role of stabilizing the membrane, of absorbing the atmospheric water without creating pockets, and of absorbing impacts, including those, inter alia, caused by the falling of raindrops or of hailstones. It makes it possible to prevent running of water. It also has the objective of protecting the impermeabilizing layer containing the water-soluble polymer(s) since the latter can be degraded by UV radiation, the temperature and oxidation in the presence of metal ions.

The stabilizing layer advantageously contains:
from 5 to 30% by weight of plant fibers,
from 5 to 15% by weight of hydraulic binder,
the remainder to 100% by weight being water.

The stabilizing layer can also contain:
up to 5% by weight of an organic liquefying agent, such as, for example, a water-soluble polymer based on acrylamide, lecithin, silicone compounds, guar gum, algal extracts, extract of Cyamopsis tetragonoloba and of red algae, the role of which is to facilitate the application by spraying and the flow in the pipes,
up to 15% by weight of polymer fibers, for example polyester or viscose fibers, or polyethylene fibers, or aramid fibers, making it possible to improve the tensile strength and the puncture resistance;
gelling agents, carboxymethylcellulose or other guar gums, barks, coconut fibers, straw, inorganic fillers such as bentonite, smectite, talc or kaolin.

According to the present invention, the expression “hydraulic binders” is intended to mean any compound having the property of hydrating in the presence of water and the hydration of which makes it possible to obtain a structure having a mechanical strength. As an example of a hydraulic binder, mention will be made of cements, plasters, clays and all gypsum-based binders.

The plant fibers are fibers mainly composed of cellulose and/or of hemicelluloses and/or of lignins and/or of pectins. Preferentially, they will be fibers of wood obtained by mechanical defibering with heat treatment under pressure. The wood essences mainly used will be Pinus, Betula payrefera/Populus tremuloides, without this being limiting.

This second layer will be applied in the liquid state, advantageously by hydraulic projection, i.e. by spraying. Equipment of hydroseeder® type will be used for the application.

The second layer is applied at a thickness of between 1 and 50 mm, preferably from 3 to 10 mm. The thickness of the plant layer may vary according to the rainfall indices. In a region with high rainfall, the thickness will be greater.

The term “temporary covering” is intended to mean a protection over a period that can range from 1 day to 2 years, preferentially from 1 week to 6 months.

Preferentially, the layers are applied by spraying using, for example, a hose. Equipment of hydroseeders® type, fitted with a blade mixer, are most suitable for this type of application. This equipment is easy to fill, make application easy, either by spraying from the truck or the ground via pipes that are dragged, and easy to clean. The most widespread brands are Euroseeder®/Finn®/Scheier®/Bowie®, although other equipment is also available on the market.

This mode of application makes it possible to apply the layers, including on sloping or uneven ground. When the slope is greater than 20%, a synthetic or plant geotextile, for example based on coconut fibers, may be added to the bare soil and before applying the first layer. It will make it possible, on sloping banks, to form a flexible framework that will facilitate the maintaining of the applied layers.

The contaminated soil to be treated does not require a particular treatment. Nevertheless, if its configuration shows bumps or other particularities, leveling-packing down using machines intended for this purpose may be envisioned.

The process according to the invention is of quite particular interest in the following applications:
provisional coverings of polluted soils, stored optionally as a pile on site, which need to be covered because they emit volatile pollutants, soluble pollutants and/or harmful or toxic dusts, which have an impact on the air and on water;
provisional coverings of zones awaiting to be excavated;
coverings of swathes of land (or coal tips) subjected to microbial biological depollution (involving either or both phase(s));
artificial mulching;
encapsulation of contact herbicide in the spongy layer (combating invading plants);
provisional coverings for limiting gases and odors being given off;
daily covering of CET, of coal tips.

The process according to the invention can also be of interest for other applications, such as the covering of coal tips or of other inorganic or organic materials in the form of solid particles.

In one particular embodiment, at least one plant layer is applied to the stabilizing layer.

In another embodiment, at least two successive layers, respectively at least one leakproof layer and then one plant layer, are applied to the stabilizing layer.

In the two cases, this additional protection operation has the advantage of not requiring any additional operation before reapplying at least one layer.

The combination of an impermeabilizing layer and of a plant layer makes it possible to simply obtain excellent liquid-proof and gas-proof performance levels, limiting to the maximum the propagation of the contaminants present at the surface of the soil to the deeper layers, and to prevent the evaporation of volatile contaminants, such as VOCs, into the atmosphere, and also harmful or toxic dust.

The implementation of the process is simplified because the membrane is composed only of two layers and it is particularly simplified when these two layers are applied by spraying.

The use of the process is thus simplified because it is applicable on any type of soil having any morphology, including on sloping parts such as banks. Furthermore, it does not require any particular maintenance and does not therefore require any intervention throughout the duration of the encapsulation.

The destruction of the membrane at the end of the works is simplified because the membrane does not require any treatment of particular waste other than that initially provided for for treating the contaminated soil.

The examples hereinafter make it possible to illustrate the invention, but are in no way limiting in nature.

### Example

The tests are carried out on an industrial site with a surface area of approximately 2 ha, having over the years undergone many modifications and experienced various incidents (fire/bombardments during the 2nd world war, explosion, industrial exploitation).

The current soil depollution worksite requires the use of means for temporary containment of the areas polluted with VOCs (Volatile Organic Compounds).

The tests consist in comparing the effectiveness of the temporary protections on this area identified as polluted with VOCs and in monitoring over time the contents of VOCs present at the surfaces of the area covered.

### Prior Art Solution: Covering with Covers

This “prior art” solution set up as a control comprises placing on the soil a complex consisting of a thick geomembrane ( 5/10th), which is itself protected from the soil by a geotextile having a density of 500 g/m². The complex is held in place by ballast bags.

### Solution According to the Invention

Using a hydroseeder®, the following two layers having the compositions detailed below are successively applied to the bare soil:

1. The impermeabilizing layer is applied at a thickness of 2 mm and has the following composition (% by weight)

| | |
|---|---|
| water | 98.06% |
| inverse emulsion of acrylamide/acrylic acid copolymer, | 0.77% |
| 30% anionic with a molecular weight of 10 million g/mol | |
| Floset S44 (filmforming compound) | 0.97% |
| 0.1N sodium hydroxide | 0.10% |
| glyoxal | 0.10% |

2. The stabilizing layer is applied at a thickness of 5 mm and has the following composition (% by weight)

| | |
|---|---|
| water | 93.53% |
| mulch | 5.16% |
| linear polyacrylamide | 0.02% |
| gypsum | 1.29% |

The mulch is composed of wood fibers obtained by mechanical defibering with heat treatment under pressure, of which the wood essences are Pinus, Betula payrefera/Populus tremuloides.

After determining an initial state acting as point zero of the state of degassing of the subsoil, compared measurements aimed at demonstrating the leakproofing and the effectiveness of the containment materials are carried out over a period of one month. Over the course of these tests, the recording of the environmental parameters and of the observations on aging of the fibrillar membranes completes the analyses carried out during the tests (broad-spectrum measurements for determining the presence of the various VOCs originating from the polluted soil).

The passing or not passing of the VOCs through the various membranes:
indicates whether or not the encapsulating principle is effective in preventing the VOCs resulting from the degassing of the soils to the atmosphere;
reveals whether or not the processes implemented have the ability to limit the penetration of atmospheric water into the soils.

The ground measurements relating to the tests carried out on fibrillar membranes were carried out using a photoionization gas detector or PID (Photovac 2020). This material makes it possible to characterize and to measure the volatile organic compounds (VOCs) quantitatively. It is equipped with a broad-spectrum UV lamp (10.6 eV), suitable for measuring all volatile organic compounds, in particular organochlorine compounds and BTEX compounds.

On the site, the products are present in the form of a mixture essentially consisting of:
halogenated volatile organic compounds (HVOCs);
benzene, ethylbenzene, toluene and xylenes (BTEX compounds);
volatile linear hydrocarbons;
aldehydes.

The measurements are expressed in ppm. They are carried out twice a week at the surface of the two containments, at places that will have been pinpointed beforehand by means of labeling. The measuring instrument is placed above the measuring point, in a measuring chamber consisting of a flask made of PE, open at the bottom.

### Results

No emanation of VOC was detected above the two protections throughout the test period, thereby confirming the excellent protective effectiveness of the protection according to the invention. The latter additionally has as an advantage over the prior art protection:
that of being easier to implement,
that of being easy to maintain because there is no daily maintenance when it is windy.

Moreover, other tests made it possible to demonstrate the leaking of VOCs in the regions of overlap between the covers of the prior art protection. The process according to the invention therefore allows optimized protection.

Finally, tests carried out on banks made it possible to demonstrate the ease with which the process of the invention can be implemented on sloping ground and the effectiveness of said process, since no detection of VOCs was observed.

Finally, the protection according to the invention was shown to be of great advantage during the storms that occurred during the test period, since the stabilizing layer played its role of shock absorber associated with the falling of the drops, and water absorber; water accumulation was not observed.

What is claimed is:

1. A process for temporary covering of contaminated soils, comprising: applying, to the soil, a leakproof layer based on a water-soluble polymer, and then subsequently applying a stabilizing layer based on plant fibers.

2. The process as claimed in claim 1, wherein the leakproof layer contains:
from 0.05 to 3% by weight of at least one water-soluble polymer,
from 0.05 to 4% by weight of a film-forming compound;
from 0.001 to 2% by weight of a crosslinking agent comprising at least 2 aldehyde functions;
the remainder to 100% by weight being water.

3. The process as claimed in claim 1, wherein the water-soluble polymer is obtained from:
at least one nonionic monomer chosen from the group consisting of: acrylamide, methacrylamide, N-vinylmethylacetamide, N-vinylformamide, vinyl acetate, vinylpyrrolidone, methyl methacrylate, dimethylacrylamide, acryloyl morpholine, styrene and acrylonitrile.

4. The process as claimed in claim 1, wherein the water-soluble polymer is nonionic, has a molecular weight of greater than 1 million g/mol and is in the form of an inverse emulsion.

5. The process as claimed in claim 1, wherein the leakproof layer is applied in a liquid state to the soil to be treated at a thickness of between 1 and 50 mm.

6. The process as claimed in claim 1, wherein the stabilizing layer contains:
from 5 to 30% by weight of plant fibers,
from 5 to 15% by weight of hydraulic binder,
the remainder to 100% by weight being water.

7. The process as claimed in claim 6, wherein the hydraulic binder is chosen from the group consisting of cements, plasters, clays and all gypsum-based binders.

8. The process as claimed in claim 1, wherein the stabilizing layer is applied in a liquid state to the leakproof layer at a thickness of between 1 and 50 mm.

9. The process as claimed in claim 1, wherein the layers are applied by spraying.

10. The process as claimed in claim 1, wherein, prior to application of the leakproof layer, a synthetic or plant geotextile is applied to the soil.

11. The process as claimed in claim 2, wherein the film-forming compound comprises a polymer or copolymer obtained from styrene and/or butene and/or acrylic and/or vinyl monomers.

12. The process as claimed in claim 2, wherein the at least 2 aldehyde functions, comprise glyoxal.

13. The process as claimed in claim 3, further comprising:
copolymerizing with one or more cationic monomers chosen from the group consisting of: diallyldialkylammonium salts, diallyldimethylammonium chloride (DADMAC), dialkylaminoalkyl methacrylates, dialkylaminoethyl acrylate (ADAME) and dialkylaminoethyl methacrylate (MADAME), and also the acidified or quaternized salts thereof, benzyl chloride, methyl chloride (MeCl), aryl chlorides, alkyl chlorides, dimethyl sulfate, diethyl sulfate and dialkyl-aminoalkylacrylamides or -methacrylamides, and also the acidified or quaternized salts thereof, methacrylamidopropyltrimethylammonium chloride (MAPTAC) and Mannich products, quaternized dialkylaminomethylacrylamides.

14. The process as claimed in claim 13, further comprising:
copolymerizing with one or more anionic monomers, monomers having a carboxylic function, monomers having a sulfonic acid function, vinylsulfonic acids, and ethylene glycol methacrylate phosphate.

15. The process as claimed in claim 5, wherein the leakproof layer is applied in a liquid state to the soil to be treated at a thickness of between 2 and 10 mm.

16. The process as claimed in claim 8, wherein the stabilizing layer is applied in a liquid state to the leakproof layer at a thickness of between 3 to 10 mm.

17. The process as claimed in claim 10, wherein, the synthetic or plant geotextile applied to the soil is based on coconut fibers.
